(19) United States
(12) Patent Application Publication
(10) Pub. No.: US 2023/0145437 A1
(43) Pub. Date: May 11, 2023

(54) EXECUTION PREDICTION FOR COMPUTE CLUSTERS WITH MULTIPLE CORES

(71) Applicant: Hewlett-Packard Development Company, L.P., Spring, TX (US)

(72) Inventors: Carlos Haas Costa, Palo Alto, CA (US); Ewerton Lopes Silva de Oliveira, Porto Alegre (BR); Marco Aurelio Da Silva Cruz, Porto Alegre (BR); Raphael Gay, Fort Collins, CO (US)

(73) Assignee: Hewlett-Packard Development Company, L.P., Spring, TX (US)

(21) Appl. No.: 17/913,181

(22) PCT Filed: Apr. 8, 2020
(86) PCT No.: PCT/US2020/027288

§ 371 Date: Sep. 21, 2022

(51) Int. Cl. G06F 9/48; G06F 1/08

(52) U.S. Cl. CPC G06F 9/4887; G06F 1/08

(57) ABSTRACT

Systems and methods are described herein to estimate or calculate an execution time for a compute cluster to execute a task based on the number of cores the compute cluster has relative to the number of cores present in a heterogeneous compute cluster for which the time to complete the task was previously measured. In some examples, minimum and maximum scaling ratios are calculated for compute clusters having a different number of cores than a compute cluster for which the time to complete the task has been measured.

### BACKGROUND

Portions of some workloads and applications may be processed in parallel and independent of one another, while other workloads and applications may be processed sequentially. Large-scale machine learning applications may be distributed among numerous compute nodes for parallel processing, while single threaded applications may not be easily divisible.

Some computer systems may include a single core for sequential processing, while others computer systems may include multiple cores for parallel processing. The time required to execute a given application may depend on the way the application is written, the processor speed of the executing computer system, and the number of cores in the computing system.

### BRIEF DESCRIPTION OF THE DRAWINGS

The written disclosure herein describes illustrative examples that are nonlimiting and non-exhaustive. Reference is made to certain of such illustrative examples that are depicted in the figures described below.

FIG. 1 illustrates an example block diagram of a workload orchestration system to orchestrate machine learning workloads among heterogeneous compute clusters with different numbers of cores.

FIG. 2A illustrates a specific example of cluster management of an artificial intelligence application via a workload orchestration system in a heterogeneous network of on-premises compute devices.

FIG. 2B illustrates a block diagram of example subsystems of the artificial intelligence scheduler of FIG. 2A.

FIG. 3 illustrates a block diagram of an example workload orchestration system implemented in a computer system.

FIG. 4 illustrates a flowchart of a method to allocate workloads of a machine learning application to heterogeneous compute clusters based on discovered resources, estimated thread scaling ratios, and estimated resource demands.

FIG. 5A illustrates an example block diagram of a multithreaded application with full upscaling with additional cores.

FIG. 5B illustrates an example block diagram of a multithreaded application without any upscaling with additional cores.

FIG. 6A illustrates an example block diagram of a multithreaded application that only uses some cores and does not upscale with additional cores.

FIG. 6B illustrates an example block diagram of a multithreaded application that only uses some cores and upscales with a constant number of reserved cores.

FIG. 6C illustrates an example block diagram of a multithreaded application that only uses some cores and upscales with a constant ratio of utilized cores to reserved cores.

FIG. 7 illustrates an example block diagram of a multithreaded application that downscales with all cores utilized.

FIG. 8 illustrates an example block diagram of a multithreaded application that only uses some cores and downscales with all cores utilized.

FIG. 9 illustrates an example block diagram of a multithreaded application that only uses some cores and downscales with a constant number of reserved cores.

FIG. 10 illustrates an example block diagram of a multithreaded application that only uses some cores and downscales with a constant ratio of utilized cores to reserved cores.

FIG. 11 illustrates a flow chart of an example approach to calculate minimum and maximum thread scaling ratios.

### DETAILED DESCRIPTION

As used herein, a compute cluster may be defined in terms of the collective available compute resources of multiple compute nodes, each of which may have a different number of cores for executing multithreaded applications. A compute cluster includes at least one compute node but may include multiple compute nodes. In a cloud computing environment, the various compute nodes can be selected to have homogeneous or near homogeneous compute resources. Some tasks, such as large-scale data processing, can be divided into any number of increasingly smaller and simpler workflows for parallel processing based on the number of discrete compute nodes and available compute resources. In contrast, single-threaded applications may benefit more from increased process speed instead of an increased number of processing cores.

As used herein, the term workload includes specific compute jobs or tasks and an associated or underlying dataset. For example, a workload may include the execution of a particular application or portion of an application. Each compute job or task may include instructions for actions to be taken with respect to the associated dataset. Thus, each compute job or task may include the execution of an application with respect to an associated dataset.

In some instances, it may be desirable to execute artificial intelligence or other machine learning applications using on-premises compute devices and/or edge devices. Unlike in a cloud computing environment, on-premises compute devices and edge devices may each have widely different compute resources. Thus, while a cloud computing environment can be modeled as a plurality of distributed compute clusters with homogeneous compute resources, on-premises and/or edge device networks are more accurately described as a plurality of distributed compute clusters with heterogeneous compute resources.

Examples of compute resources include, without limitation, central processing unit (CPU) resources, GPU resources, volatile memory resources, network communication capabilities, persistent storage resources, and the like. For example, compute resources of homogeneous or heterogeneous compute resources may be quantified and compared in terms of a function of one or more of available volatile memory, available persistent storage, processor clock speed, floating-point operations per second (“flops”), number of compute cores or processors, memory speed, network bandwidth, and the like. The assignment of machine learning workloads in a heterogeneous compute network can result in underutilization of some compute clusters and/or asynchronous learning parameter exchanges between compute clusters.

Some applications may be executable or at least partially executable by multicore processors in parallel, while others may not. For instance, a fully multithreaded application may be executed by a compute node having four cores much faster than if the same application is executed by a compute node having a single core. The performance difference between various compute node configurations may depend partially on the number of cores in each compute node, but only to the extent that the application being executed can take advantage of additional cores. Thus, a compute node with 12 cores may not necessarily execute an application faster than an otherwise similar compute node that only has 6 cores.

As used herein, the term “core” or “cores” may refer to physical or virtual cores (threads) implemented by processors and/or virtual machines. In many examples, the evaluation of what constitutes a “core” may be based on what is exposed to the operating system or operating systems of the machine (physical or virtual) on which the application is executed.

The presently described systems and methods may estimate the amount of time it will take to execute an application or other task on a given compute node. For example, some tasks or applications may not scale at all when additional cores are available. Such tasks or applications may have a thread scaling ratio of 1, indicating that the presence of additional cores will not result in a faster execution time of the task or application. In contrast, some tasks or applications may be fully scalable to utilize the full number of cores available. As described herein, some tasks or applications may partially scale to include a constant number or fixed ratio of utilized cores and reserved cores. The hyperparameters associated with each workload may be defined or adjusted to compensate for the different processing speeds and number of cores in each compute cluster to which it is assigned.

In one example, a workload orchestration system includes a discovery subsystem to identify the specific compute resources of each compute cluster in a network of computer clusters (e.g., heterogeneous compute clusters). The system may determine the number of cores available in the various compute clusters. A manifest subsystem may receive or generate a manifest that describes the resource demands for each workload associated with an application, such as a single-threaded application, an artificial intelligence application, a machine learning application, or other application. The system may estimate an execution time for the various workloads based on a scaling ratio associated with the workload and the number of cores in each compute cluster. A placement subsystem may assign each workload to one of the compute clusters by matching or mapping the resource demands of each workload and the compute resources of each compute cluster. The placement subsystem may assign each workload in further consideration of affinity, anti-affinity, and/or co-locality constraints and policies. An adaptive modeling subsystem may dynamically define (e.g., establish, set, or modify) hyperparameters for each workload as a function of the identified compute resources of the compute cluster to which each respective workload is assigned and the dataset.

For example, a discovery subsystem or module may determine a measured execution time for a first compute cluster with a first number of cores to execute a task. A manifest subsystem or module may identify resource demands for each workload. A scaling subsystem or module may calculate thread scaling ratios (e.g., minimum and maximum thread scaling ratios) for the application indicative of the scalability of the application across the compute clusters having variations in the number of cores. For example, the thread scaling ratios may be calculated based on a measured execution time for a first compute cluster with a first number of cores to execute the application.

A placement subsystem may assign each workload to one of the compute clusters by matching the identified resource demands of each respective workload using the calculated thread scaling ratios for the application and the identified compute resources of each compute cluster (including the number of cores in each respective compute cluster).

An adaptive modeling subsystem may define hyperparameters of each workload based, at least in part, on the calculated thread scaling ratio and the number of cores in each respective compute cluster to which each respective workload is assigned.

Various modules, systems, and subsystems are described herein as implementing functions and/or as performing various actions. In many instances, modules, systems, and subsystems may be divided into sub-modules, subsystems, or even as sub-portions of subsystems. Modules, systems, and subsystems may be implemented in hardware or as processor-executable instructions stored in, for example, a non-transitory computer-readable medium. Some examples may be embodied as a computer program product, including a non-transitory computer and/or machine-readable medium having stored thereon instructions that may be used to program a computer (or another electronic device) to perform processes described herein.

The examples of the disclosure may be further understood by reference to the drawings. It is readily understood that the components of the disclosed examples, as generally described and illustrated in the figures herein, could be arranged and designed in a wide variety of different configurations. Thus, the following detailed description of the examples of the systems and methods of the disclosure is not intended to limit the scope of the disclosure, as claimed, but is merely representative of possible examples of the disclosure. In addition, the elements of a method do not necessarily need to be executed in any specific order, or even sequentially, nor do the elements need to be executed only once, unless otherwise specified. In some cases, well-known features, structures, or operations are not shown or described in detail.

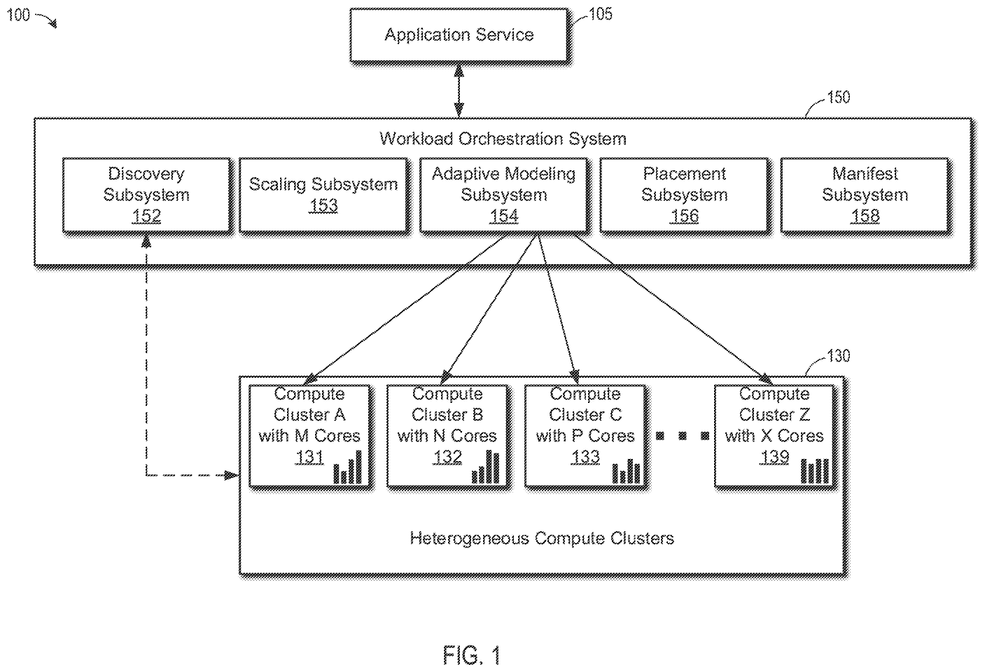

FIG. 1 illustrates an example block diagram 100 of a workload orchestration system 150 to orchestrate machine learning workloads among heterogeneous compute clusters 130. An application service 105, such as an artificial intelligence application or other machine learning application, may communicate with the workload orchestration system 150 for distributed execution. The workload orchestration system 150 includes a discovery subsystem 152, an adaptive modeling subsystem 154, a placement subsystem 156, and a manifest subsystem 158.

The discovery subsystem 152 identifies or otherwise profiles the individual compute resources of each of the compute clusters A, B, C, and Z (131, 132, 133, and 139) that are part of the heterogeneous compute clusters 130. The network of heterogeneous compute clusters 130 may include any number of compute clusters, but only four are illustrated in the example. The compute clusters A, B, C, and Z (131, 132, 133, and 139) may have various combinations of compute resources, graphically illustrated by bar charts in the lower right corner of each compute cluster 131-139. For instance, each compute cluster 131-139 may have different CPU resources, GPU resources, volatile memory resources, network bandwidth, network latency characteristics, persistent storage resources, or the like. Each compute cluster 131-139 may have a different number of cores, illustrated as M, N, P, and X integer values that differ from one another.

In some examples, the discovery subsystem 152 may identify the total (e.g., theoretical) compute resources of each compute cluster 131-139, currently available compute resources of each compute cluster 131-139, and/or expected or scheduled availability of compute resources of each compute cluster 131-139 during a future time window. Some compute clusters may have the same compute resources as one another, while others may be heterogeneous.

A scaling subsystem 153 may calculate thread scaling ratios for the application indicative of the scalability of each of a plurality of workloads for the various compute clusters. The thread scaling ratios may be calculated based on a measured execution time for a first computer cluster with a first number of cores. For example, the thread scaling ratios may be calculated based on a measured execution time for a first compute cluster with a first number of cores to execute the application. The system may calculate minimum and maximum estimated execution times for each respective compute cluster that has a different number of cores based on the thread scaling ratios. As described herein, the minimum and maximum thread scaling ratios may, in some instances, be the same value.

The manifest subsystem 158 may maintain a manifest that describes or specifies the resource demands for each of a plurality of workloads that implement the application service 105. In some examples, the manifest subsystem 158 divides the application service 105 into the plurality of workloads based on the compute resources of the compute clusters 131-139 identified by the discovery subsystem 152. For example, the workloads may be intentionally selected to have resource demands that correspond to the identified compute resources of the compute clusters 131-139. In other embodiments, the manifest subsystem 158 may receive a manifest that describes the resource demands of predefined workloads that are, for example, specified by the application service 105 independent of the identified compute resources of the compute clusters 131-139.

A placement subsystem 156 allocates each workload to one of the compute clusters 131-139. For example, the placement subsystem 156 may match workloads of the application service 105 as defined in the manifest subsystem 158 with compute clusters 131-139 by matching the resource demands of each respective workload with the identified compute resources of each of the compute clusters 131-139. The placement subsystem 156 may allocate workloads with compute clusters 131-139 based, at least in part, on the number of cores in each compute cluster and the calculated thread scaling ratio.

In some examples, the placement subsystem 156 implements resources-aware workload scheduling in which the resource demands comprise metrics corresponding to the identified compute resources of the compute clusters 131-139 (e.g., CPU resources, GPU resources, vCPUs, volatile memory resources, network bandwidth, network latency characteristics, persistent storage resources, or the like). In other examples, the placement system 156 additionally implements models-aware workload scheduling in which the allocation of workloads to the compute clusters 131-139 is further based on co-locality, anti-affinity and/or affinity constraints and policies of workloads.

In some examples, the placement subsystem 156 may relax or ignore locality constraints based on the available compute resources. The resulting fragmentation may be resolved through migration and defragmentation, as described herein. That is, while the placement subsystem 156 may implement resources-aware and models-aware workload assignments, sometimes the models-aware constraints may be relaxed or even ignored based on limitations of the available compute resources. The workload orchestration system 150 may migrate workloads from one compute cluster 131-139 to another compute cluster 131-139 after partial or complete execution to satisfy affinity and/or co-locality constraints. The workload orchestration system 150 may implement a checkpoint approach that allows for the restoration of machine learning models to avoid rerunning, for example, training from the beginning.

In some examples, the placement subsystem 156 may assign each workload to one of the compute clusters based on a matching of (i) the identified resource demands of each respective workload, (ii) the calculated thread scaling ratios for the application, and (iii) the identified compute resources of each compute cluster, including the number of cores in each respective compute cluster.

An adaptive modeling subsystem 154 sets, adjusts or otherwise defines the hyperparameters of each workload as a function of the identified compute resources of the compute cluster 131-139 to which each respective workload is assigned. The hyperparameters of a workload assigned to the compute cluster A 131 may be different than the hyperparameters of a workload assigned to the compute cluster B 132 due to the different compute resources of compute clusters A and B (131 and 132, respectively). For instance, different batch sizes, number of epochs, learning rates, and/or other hyperparameters may be assigned to the workload(s) assigned to compute cluster A 131 than to the workload(s) assigned to compute clusters B-Z (132-139). The system may reduce straggler issues by dynamically modifying the hyperparameters of the workloads assigned to the various heterogeneous compute clusters 131-139 to synchronize or more closely synchronize execution of the workloads.

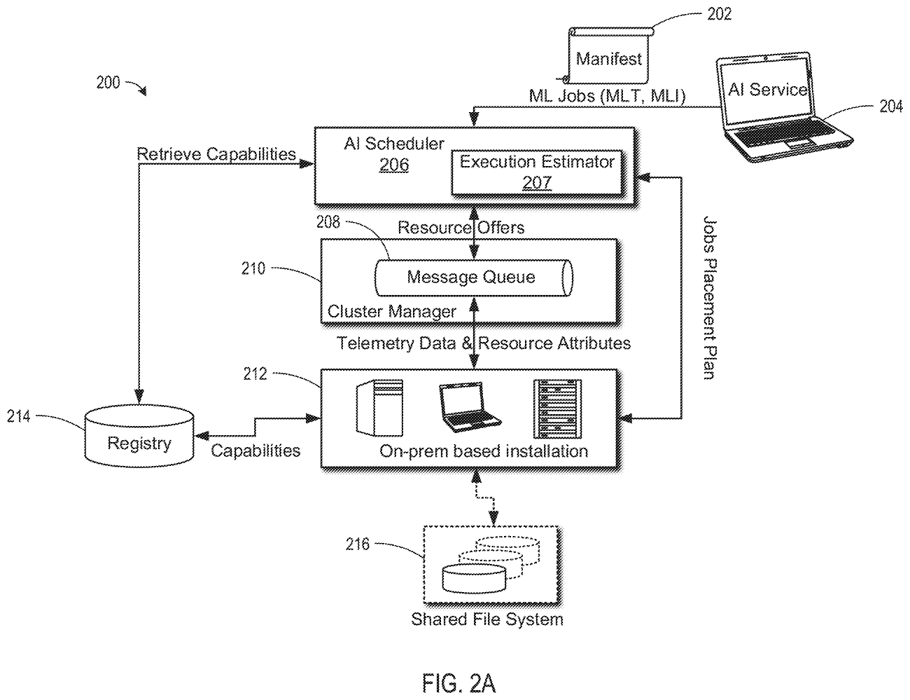

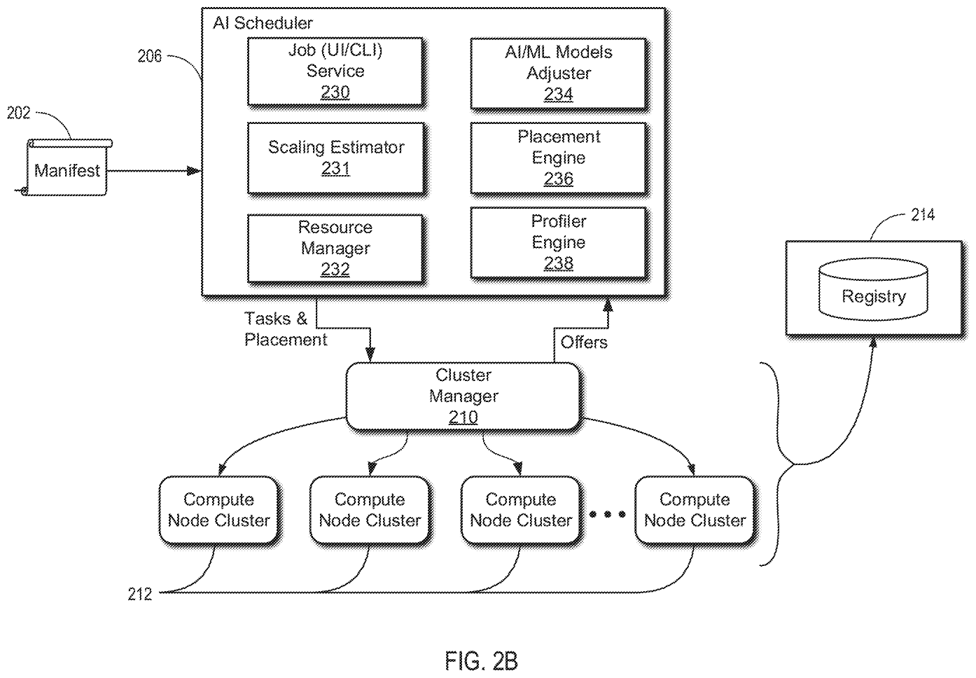

FIG. 2A illustrates a specific example of cluster management of an artificial intelligence application 204 via a workload orchestration system 200 comprising a manifest 202, an artificial intelligence scheduler 206, an execution estimator 207, a cluster manager 210, and a registry 214. The workload orchestration system 200 may implement cluster management in the heterogeneous network of on-premises compute devices 212. The manifest 202 may specify the resource demands for each of a plurality of workloads associated with the artificial intelligence application 204. The cluster manager 210, messaging queue 208, execution estimator 207, and the artificial intelligence scheduler 206 may be components of a placement subsystem that allocates each workload of the artificial intelligence application 204 to one of the compute devices in the network of on-premises compute devices 212 by, for example, matching the resource demands of each respective workload with identified compute resources of each respective compute device.

The registry 214 may be maintained by a discovery subsystem, as previously described. In some examples, the registry 214 may be a dynamic database identifying the compute resources of each of the compute devices in the network of on-premises compute devices 212. The workload orchestration system 200 may also set, adjust, or otherwise define the hyperparameters of each assigned workload as a function of the identified compute resources of the compute devices in the network of on-premises compute devices 212. The discovery subsystem may acquire or reserve compute resources as they become available. Accordingly, since compute resource availability is dynamic, the workload orchestration system 200 may use a hysteresis margin to acquire resources with appropriate locality and/or affinity to meet the corresponding resource demands of the workload(s).

The workload orchestration system 200 may assign workloads to the compute devices in the network of on-premises compute devices 212 in a resources-aware manner. That is, the workload orchestration system 200 may assign workloads to the compute devices by matching or mapping the compute resources of each compute device with the resource demands of each workload. In some examples, the workload orchestration system 200 may also assign the workloads to the compute devices in a models-aware manner. That is, the workload orchestration system 200 may assign the workloads to the compute devices in further consideration co-locality constraints, anti-affinity, and/or affinity constraints and policies of the workloads.

The workload orchestration system 200 may isolate workloads (e.g., machine learning training and interference jobs) of the artificial intelligence application 201. The workload orchestration system 200 may assign workloads to the compute devices in the network of on-premises compute devices 212 based at least in part on an evaluation of network communication costs associated with assigning workloads to distributed computing devices having the computational benefits of increased processor speeds and/or and increased number of cores.

In some examples, the workload orchestration system 200 may implement preemption policies for the compute resources of the compute devices in the network of on-premises compute devices 212 to enforce resource sharing (e.g., the shared file system 216). The preemption policies can be set to avoid using the full capacity of any one compute device and/or mitigate head-of-line issues. In some examples, if higher priority jobs arrive in the message queue 208 while there are lower priority jobs running, the system 200 may free up compute resources of the compute devices in the network of on-premises compute devices 212 to focus on the higher priority jobs. For example, the lower priority jobs may be temporarily suspended while the higher priority jobs are executed.

The artificial intelligence scheduler 206 may include an execution estimator 207 to calculate minimum and maximum estimated execution times for a compute cluster with a number of cores, N, to execute a task or application. In various examples, the execution estimator may estimate the minimum and maximum execution times for the N-core compute cluster based on a measured execution time on a different compute cluster with kN cores, where k is any number greater than 0. In some instances, the measured compute cluster may have more or fewer cores than the compute cluster for which the execution time is being estimated.

A minimum scaling ratio for the compute cluster executing the task or application may be calculated as one (i.e., unity or 1) when N is equal to or exceeds kN. When the number of cores N is less than the number of cores kN, the minimum scaling ratio is equal to the N/kN. In either case, the maximum scaling ratio may be equal to N/kN. As described herein, further refinement in the minimum and maximum scaling ratios may be calculated based on a fixed number or fixed ratio of reserved cores.

FIG. 2B illustrates a block diagram of example subsystems 230-238 of the artificial intelligence scheduler 206 of FIG. 2A, which includes an integrated scaling estimator subsystem 231. The manifest 202, cluster manager 210, network of on-premises compute devices 212, and register 214 are described above in the context of FIG. 2A. In the illustrated example, the artificial intelligence scheduler 206 includes a job service subsystem 230, the integrated scaling estimator subsystem 231, a resource manager subsystem 232, an artificial intelligence or machine learning model adjuster subsystem 234, a placement engine subsystem 236, and a profiler engine subsystem 238. The various subsystems 230-238 may be part of the discovery, adaptive modeling, and placement subsystems described herein (e.g., in conjunction with FIG. 1).

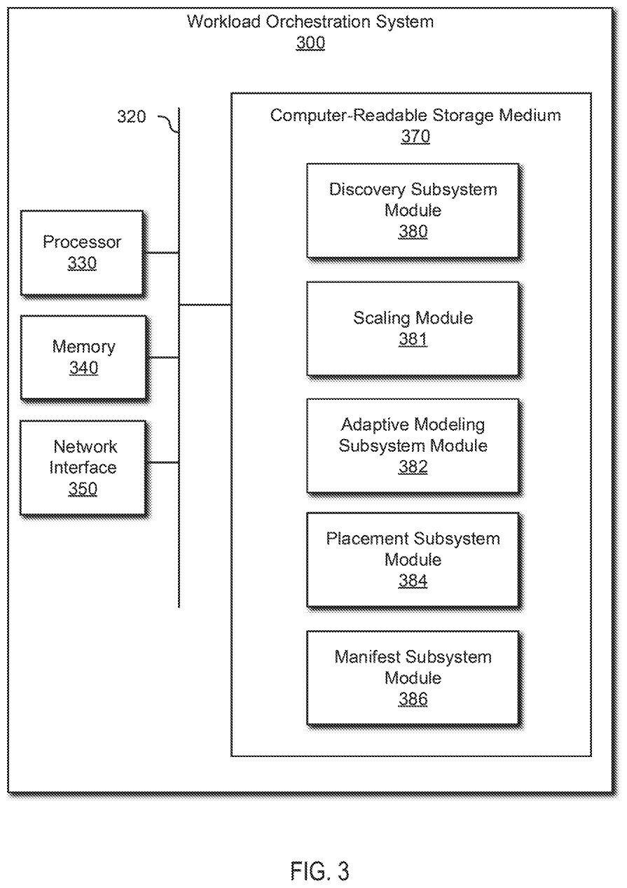

FIG. 3 illustrates a block diagram of an example workload orchestration system 300 implemented in a computer system. As illustrated, a workload orchestration system 300 may include a processor 330, memory 340, and a network interface 350 connected to a computer-readable storage medium 370 via a communication bus 320. The processor 330 may execute or otherwise process instructions stored in the computer-readable storage medium 370. The instructions stored in the computer-readable storage medium 370 include operational modules 380-386 to implement the subsystems described herein.

For example, a discovery subsystem module 380 may discover the compute resources of each compute cluster of a plurality of compute clusters. At least some of the compute clusters may have differing compute resources, including differing numbers of cores. An adaptive modeling subsystem module 382 may associate hyperparameters with each workload associated with an application (such as an artificial intelligence or other machine learning application) based at least in part on the compute resources of the compute cluster to which each respective workload is assigned.

A placement subsystem module 384 may assign each workload to a compute cluster that has compute resources corresponding to the resource demands of each respective workload. The manifest subsystem module 386 may identify resource demands of predefined workloads of an application. Alternatively, the manifest subsystem module 386 may divide an application, such as a machine learning application, into a plurality of workloads with each workload having resource demands corresponding to the compute resources of the compute clusters.

The specific arrangement of subsystems and modules may be modified from the specific examples illustrated. Accordingly, any of a wide variety of computing systems, electronics, computer-executable instructions, network configurations and the like may be adapted to implement the concepts described herein.

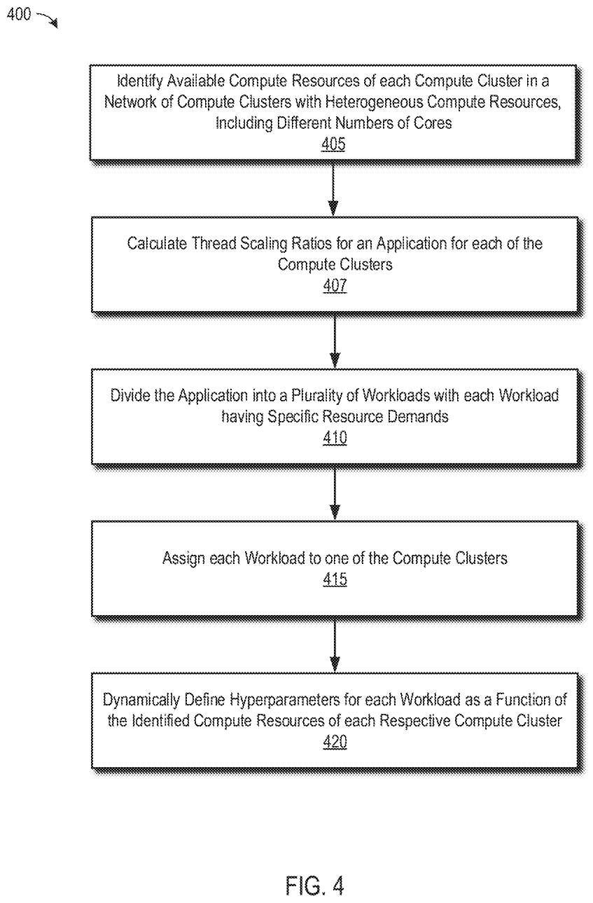

FIG. 4 illustrates a flowchart 400 of a method to allocate workloads of an application, such as an artificial intelligence application, to heterogeneous compute clusters based on discovered compute resources of individual compute clusters and estimated workload resource demands. The system may identify, at 405, available compute resources of each compute cluster in a network of compute clusters with heterogeneous compute resources, including different numbers of cores. The system may identify resource demands of predefined workloads of an application. The system may calculate, at 407, thread scaling ratios for an application for each of the compute clusters. Alternatively, the system may divide, at 410, an application, such as a machine learning application, into a plurality of workloads, with each workload having resource demands corresponding to the compute resources of the compute clusters.

The system may assign, at 415, each workload to one of the compute clusters. For example, each workload may be assigned to one of the compute clusters based on a matching between the resource demands of each workload and available compute resources of the respective compute cluster to which each workload is assigned. The system may dynamically define, at 420, hyperparameters for each workload as a function of the identified compute resources of each respective compute cluster and the dataset.

When predicting the execution time of a workload with traces collected during a run in a processor with fewer cores than the processor of a prediction target, the performance of the application may be impacted by the fact that the application may or may not upscale. When multithreaded applications are executed in processors with different numbers of cores, their behavior may be unpredictable. The present system may estimate execution times and/or thread scaling ratios for a given application based on information from one or more tests or sample executions of the application in compute nodes having different numbers of cores.

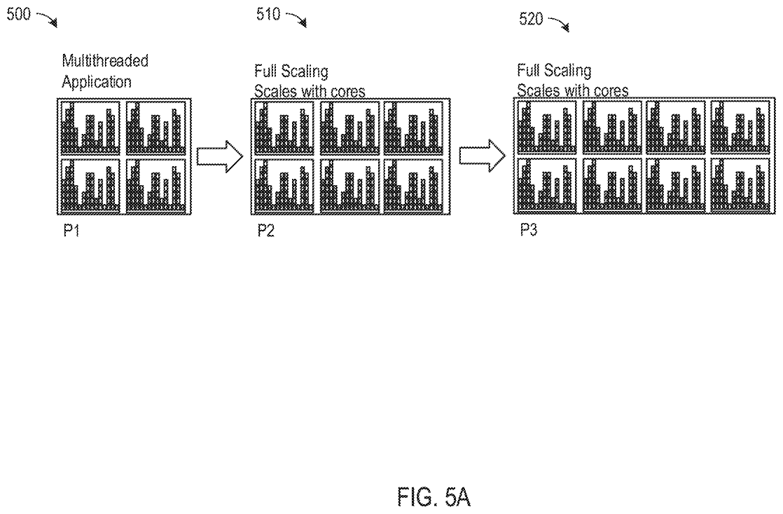

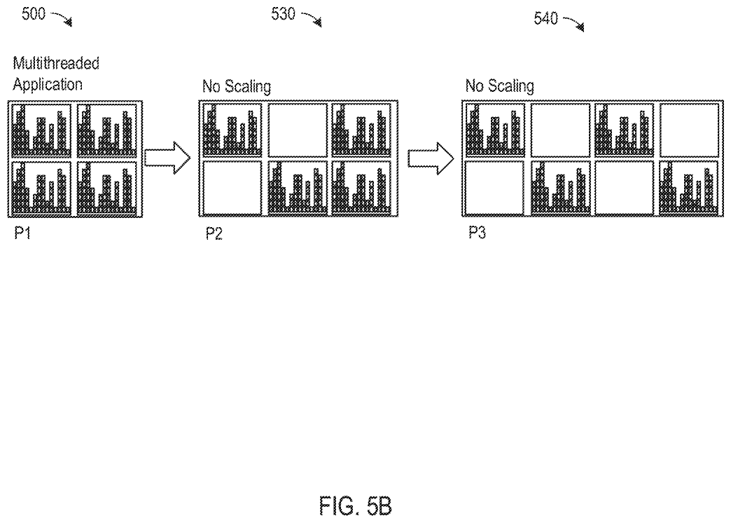

As illustrated and described in conjunction with FIGS. 5A-10, the application may scale to utilize up to a fixed maximum number of cores, scale to utilize any number of available cores, scale to utilize all cores except a fixed number of reserved cores, scale to utilize a fixed ratio of utilized cores and reserved cores. The scaling may be defined in terms of upscaling or downscaling, as described herein.

The system may utilize a known thread scaling ratio as a data point for assigning workloads between various compute clusters. The prediction accuracy of the execution time by each compute cluster is improved by using bounded thread scaling ratios. Even outside the context of dividing machine learning tasks among different compute clusters, the presently described systems and methods may be used to make decisions and provide suggestions for which machine or machines to utilize to execute a given application. As a specific example, a user may plan to execute an application on a primary machine that has 4 cores. The system may evaluate minimum and maximum scaling ratios calculated for the application based on measured execution times on other machines having any number of cores. The system may suggest that the user utilize a machine with more cores (e.g., 16 cores) based on a determination that the application would be able to fully utilize (or at least partially utilize) the additional cores.

FIG. 5A illustrates an example block diagram of a multithreaded application with full upscaling with additional cores. As illustrated, a multithreaded application may be executed on all four cores of the P1 compute node 500. The system may evaluate (e.g., measure the execution time) the thread scalability of the application by executing the application on a P2 compute node 510 with 6 cores and a P3 compute node 520 with 8 cores. Based on the number of cores utilized by the multithreaded application in each of the compute nodes 500, 510, and 520. The system may estimate minimum and maximum scaling ratios based on the evaluation.

In the illustrated example, the system may determine that the application will fully scale upward to utilize every available core. Thus, the minimum and maximum thread scaling ratios may be equal to one another and based on the ratio of cores in the compute node for which an execution time is being estimated relative to the number of cores in the measured compute node (or one of the measured compute nodes).

FIG. 5B illustrates an example block diagram of a multithreaded application without any upscaling with additional cores. In the illustrated example, the multithreaded application executed on the P1 compute node 500 utilizes all 4 cores. However, when the multithreaded application is executed on the P2 compute node 530 with 6 cores and on the P3 compute node 540 with 8 cores, only 4 cores are utilized. The system may determine that the application does not upscale with additional core availability.

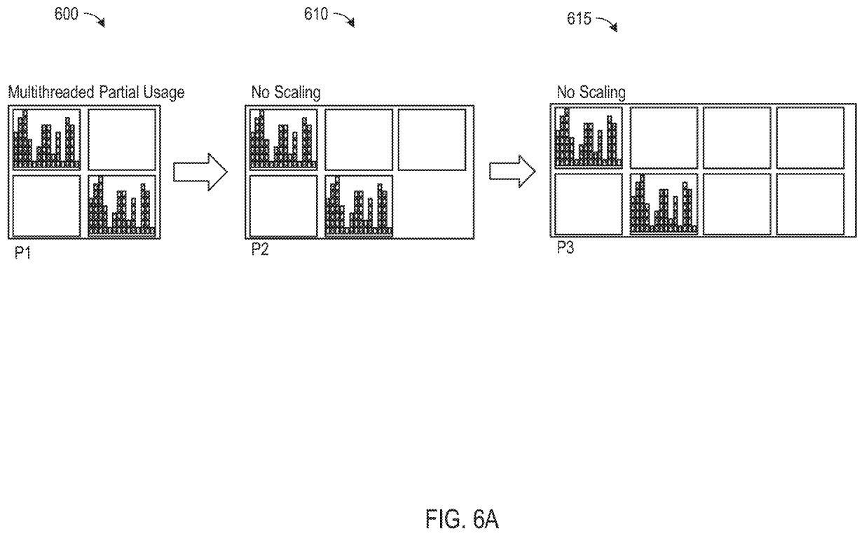

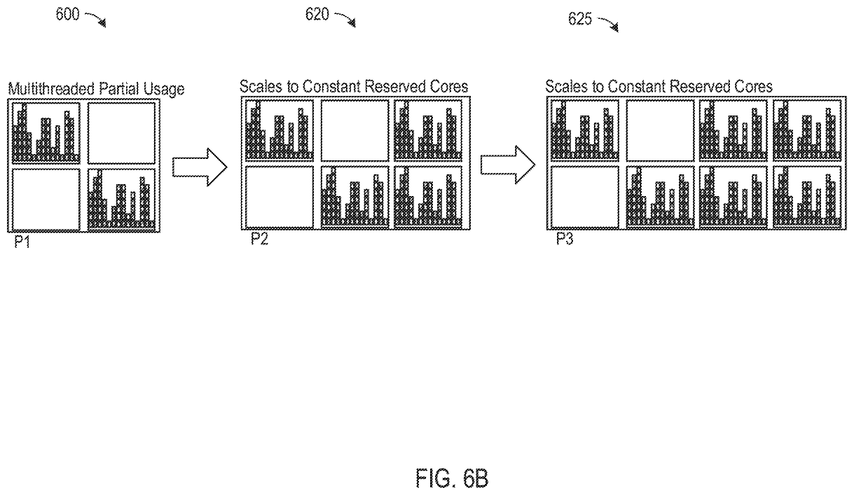

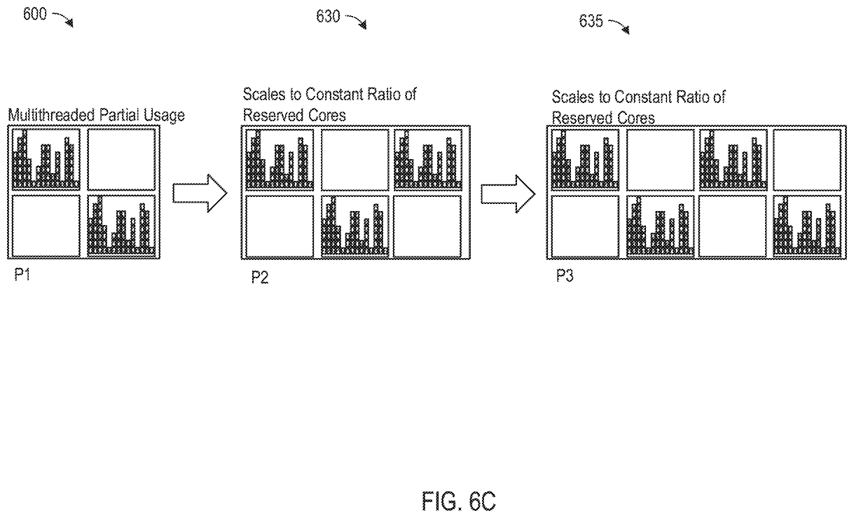

FIG. 6A illustrates an example block diagram of a multithreaded application that only uses some cores and does not upscale with additional cores. The multithreaded application only uses 2 of the 4 cores on the P1 compute node 600. The application may not scale, and so the P2 compute node 610 and the P3 compute note 615 may only see the utilization of 2 cores, even though each of the P2 compute node 610 and the P3 Compute node 615 have 6 and 8 cores, respectively.

FIG. 6B illustrates an example block diagram of the multithreaded application that only uses some cores and upscales with a constant number of reserved cores. P1 compute node 600 shows 2 cores being utilized to execute the application with two cores “reserved” (e.g., unused or utilized for purposes other than execution of the application). As illustrated, the example application scales with 2 reserved cores, regardless of the number of available cores in a given compute node. Accordingly, the P2 compute node 620 illustrates 4 cores being utilized to execute the application, and the P3 compute node 625 illustrates 6 cores being utilized to execute the application. In each case, 2 cores are reserved as either unused or for execution of instructions other than those of the application.

FIG. 6C illustrates an example block diagram of a multithreaded application that only uses some cores and upscales with a constant ratio of utilized cores to reserved cores. Again, the P1 compute node 600 shows 2 cores utilized to execute the application and 2 cores that are unused. In this example, the application scales with a constant ratio of reserved cores. The P1 compute node 600 executes with 50% of the cores executing the application and 50% of the cores reserved. Accordingly, the P2 compute node 630 illustrates 3 cores utilized and 3 cores reserved. Similarly, the P3 compute node 635 illustrates 4 cores utilized and 4 cores reserved.

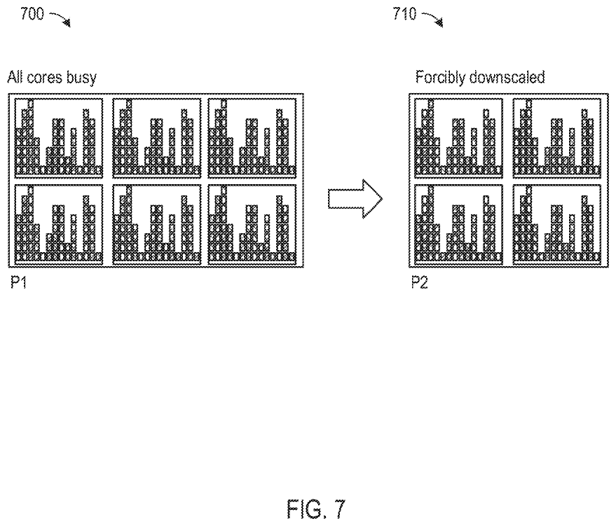

FIG. 7 illustrates an example block diagram of a multithreaded application that downscales with all cores utilized. In this example, the Application downscales to continue utilizing all available cores. The P1 compute node 700 utilizes all 6 cores and, when downscaled to the 4-core P2 compute node 710, uses the available 4 cores. Based on the available data, the system may determine that the downscaled execution of the application on the 4-core P2 compute node 710, or on a different compute node with fewer than 6 cores, will utilize all available cores.

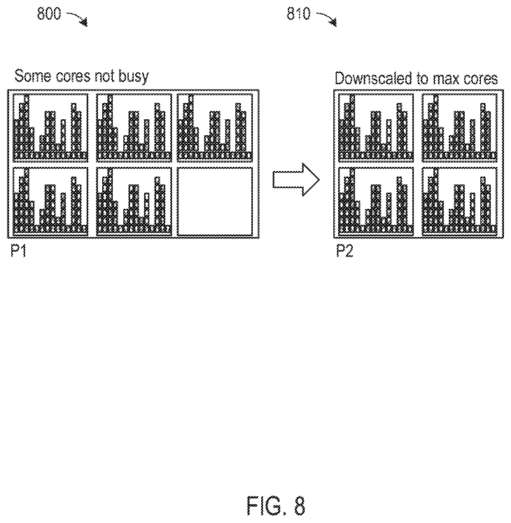

FIG. 8 illustrates an example block diagram of a multithreaded application that only uses some cores and downscales with all cores utilized. The P1 compute node 800 utilizes 5 of the 6 cores to execute the application. When downscaled for execution on the 4-core P2 compute node 810, all 4 cores are utilized for execution of the application.

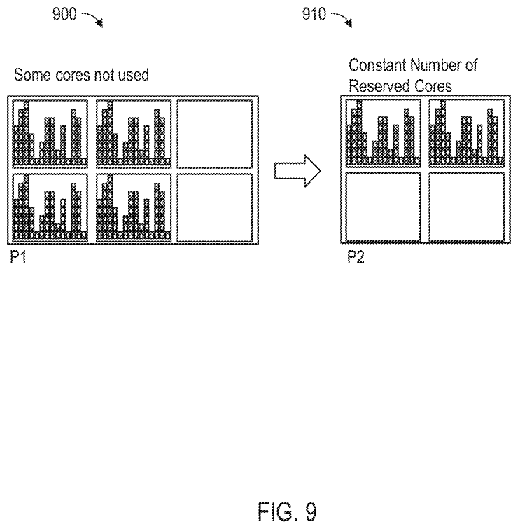

FIG. 9 illustrates an example block diagram of a multithreaded application that only uses some cores and downscales with a constant number of reserved cores. As illustrated, the P1 compute node 900 utilizes 4 of the 6 cores to execute the application, with 2 cores reserved as unused or for other purposes. The number of reserved cores may be constant. Accordingly, the P2 compute node 910 retains the constant number of 2 reserved cores, leaving 2 cores available for execution of the application.

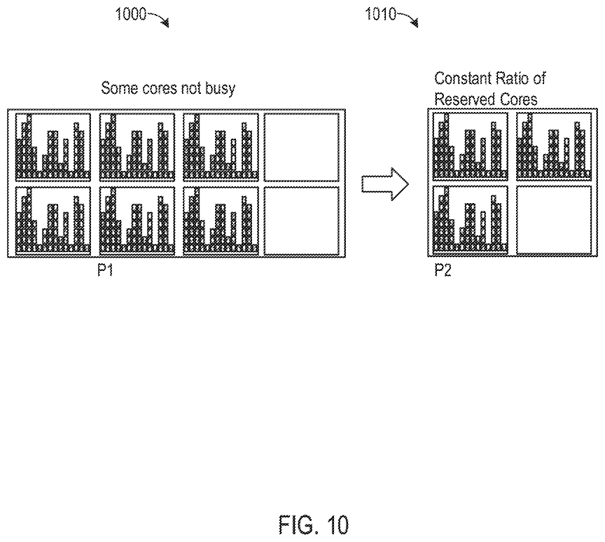

FIG. 10 illustrates an example block diagram of a multithreaded application that only uses some cores and downscales with a constant ratio of utilized cores to reserved cores. In the illustrated example, the P1 compute node 1000 utilizes 75% of the available cores for the execution of the application and reserves 25% of the cores. Accordingly, when downscaled for execution on the 4-core P2 compute node 1010, 75% of the cores (3) are utilized to execute the application, and 25% (1) are retained or reserved for other purposes.

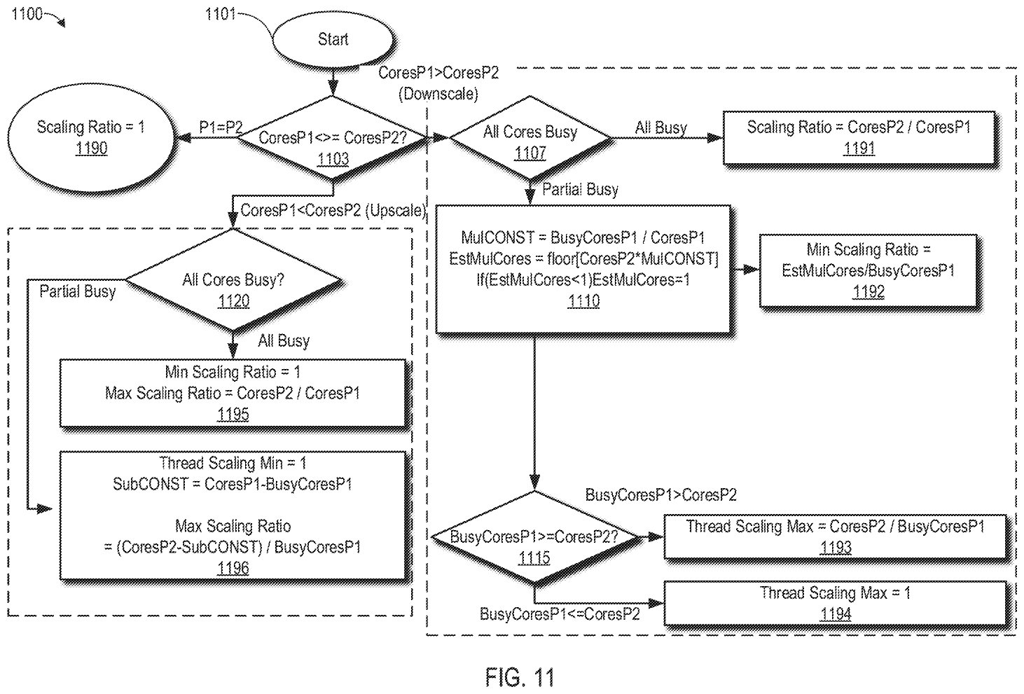

FIG. 11 illustrates a flow chart of an example approach 1100 to calculate minimum and maximum thread scaling ratios when an exact thread scaling ratio is not known. The minimum and maximum thread scaling ratios can provide guidance (e.g., another data point) for calculating minimum and maximum estimated execution times for an application on a compute node and/or for assigning each workload of a plurality of workloads to different compute clusters.

As illustrated, the start, at 1101, of the analysis begins with a comparison of the number of cores, CoresP1, in a first compute node and the number of cores, CoresP2, in a second compute node. The thread scaling ratio calculated via the approach 1100 represents the relative execution times of the first compute node and the second compute node, depending on how the application scales with compute nodes having more nodes (upscaling) or fewer nodes (downscaling), with respect to the first compute node.

As illustrated, if the first compute node has the same number of cores as the second compute node, at 1103, then the scaling ration is 1, at 1190. If the number of cores in the first compute node is greater than the number of cores in the second compute node, at 1103, then the analysis is a downscaling analysis. Following the downscaling analysis, if the application uses all of the cores in the first compute node, at 1107, then the scaling ratio is equal to the number of cores in the second compute node, CoresP2, divided by the number of cores in the first compute node, CoresP1, at 1191.

If, however, only some of the cores are used by the first compute node, at 1107, then, at 1110, a constant MulCONST is calculated as the number of cores used to execute the application in the first compute node, BusyCoresP1, divided by the total number of cores in the first compute node, CoresP1. An EstMulCores constant is then calculated as the greater of (a) 1 and (b) the number of cores in the second compute node, CoresP2, multiplied by the MulCONST. The minimum thread scaling ratio is then calculated as the EstMulCores divided by the number of cores used to execute the application in the first compute node, BusyCoresP1, at 1192.

If the number of cores used to execute the application in the first compute node, BusyCoresP1, is greater than the number of cores in the second compute node, CoresP2, at 1115, then the thread scaling max is equal to, at 1193, the number of cores in the second compute node, CoresP2, divided by the number of cores used to execute the application in the first compute node, BusyCoresP1. Otherwise, if, at 1115, the number of cores used to execute the application in the first compute node, BusyCoresP1, is less than or equal to the number of cores in the second compute node, CoresP2, then the thread scaling max is equal to 1, at 1194.

If the number of cores in the first compute node, CoresP1 is less than the number of cores in the second compute node, CoresP2, at 1103, then the system conducts an upscaling analysis. If the first compute node utilizes all of the cores to execute the application, at 1120, then the minimum thread scaling ratio is 1 and the maximum thread scaling ratio is the number of cores in the second compute node, CoresP2, divided by the number of cores in the first compute node, CoresP1, at 1195.

If, however, the first compute node utilizes only some of the cores to execute the application, at 1120, then the minimum thread scaling ratio is 1. A Subconst is calculated as the number of cores in the first compute node, CoresP1, less the number of cores used by the first compute node to execute the application, BusyCoresP1. The maximum thread scaling ratio is calculated as the difference between the number of cores in the second compute node less the SubCONST, divided by the number of cores used by the first compute node to execute the application, BusyCoresP1, at 1196.

According to various examples, the system may assign each workload to one of the compute clusters based on a matching of the identified resource demands of each respective workload, the calculated thread scaling ratios (e.g., minimum and maximum thread scaling ratios) for the application, and the identified compute resources of each compute cluster, including the number of cores in each respective compute cluster.

In some examples, a thread scaling ratio may be calculated based on a first measured execution time on a first compute node with a known number of cores and a second measured execution time on a second compute node with a second number of cores. The system may estimate an execution time for a third compute node with a third number of cores based on the calculated thread scaling ratio. The thread scaling ratio may be an exact thread scaling ratio, in which the minimum scaling ratio and the maximum scaling ratio are equal. Alternatively, the thread scaling ratio may comprise a distinct minimum thread scaling ratio and a distinct maximum thread scaling ratio. The system may use the minimum and maximum thread scaling ratios to estimate an execution time range that includes estimates for minimum and maximum execution times.

Specific examples of the disclosure are described above and illustrated in the figures. It is, however, appreciated that many adaptations and modifications could be made to the specific configurations and components detailed above. In some cases, well-known features, structures, and/or operations are not shown or described in detail. Furthermore, the described features, structures, or operations may be combined in any suitable manner. It is also appreciated that the components of the examples, as generally described, and as described in conjunction with the figures herein, can be arranged and designed in a wide variety of different configurations. Thus, all feasible permutations and combinations of examples are contemplated. Furthermore, it is appreciated that changes may be made to the details of the above-described examples without departing from the underlying principles thereof.

In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

What is claimed is:

1. A method comprising:
determining a measured execution time for a first compute cluster with a first number of cores to execute a task;
identifying a second number of cores that are in a second compute cluster;
calculating a minimum scaling ratio for the task as a function of the first number of cores and the second number of cores;
calculating a maximum scaling ratio for the task as the second number of cores divided by the first number of cores;
calculating a maximum estimated execution time for the second compute cluster to execute the task as a function of the measured execution time and the calculated minimum scaling ratio; and
calculating a minimum estimated execution time for the second compute cluster to execute the task as a function of the measured execution time and the calculated maximum scaling ratio.

2. The method of claim 1, wherein the minimum scaling ration for the task is calculated as:
one (1), upon a determination that the second number of cores is equal to or exceeds the first number of cores, and
a function of the second number of cores divided by the first number of cores, upon a determination the second number of cores is less than the first number of cores;

3. The method of claim 1, wherein each of the minimum and maximum scaling ratios is adjusted by a ratio of a clock speed of the first compute cluster and a clock speed of the second compute cluster.

4. The method of claim 1, wherein each of the minimum and maximum estimated execution times is adjusted by a ratio of a clock speed of the first compute cluster and a clock speed of the second compute cluster.

5. The method of claim 1, further comprising identifying a number of reserved cores reserved by the first compute cluster for operations other than execution of the task, and
wherein upon the determination that the second number of cores is less than the first number of cores, the minimum scaling ratio for the task, is calculated as a function of the second number of cores less the identified number of reserved cores, divided by the first number of cores less the identified number of reserved cores.

6. A workload orchestration system, comprising:
a discovery subsystem to identify compute resources of each compute cluster of a plurality of compute clusters, at least some of which have heterogeneous compute resources including different numbers of cores;
a manifest subsystem to identify resource demands for each workload of a plurality of workloads associated with an application and dataset;
a scaling subsystem to calculate thread scaling ratios for the application indicative of a scalability of the application across the compute clusters having variations in the number of cores, wherein the thread scaling ratios are calculated based on a measured execution time for a first compute cluster with a first number of cores to execute the application;
a placement subsystem to assign each workload to one of the compute clusters based on a matching of (i) the identified resource demands of each respective workload, (ii) the calculated thread scaling ratios for the application, and (iii) the identified compute resources of each compute cluster, including the number of cores in each respective compute cluster; and
an adaptive modeling subsystem to define hyperparameters of each workload based, at least in part, on the calculated thread scaling ratio and the number of cores in each respective compute cluster to which each respective workload is assigned.

7. The system of claim 6, wherein the thread scaling ratio for each set of compute clusters having a common number of cores is defined in terms of minimum and maximum estimated execution times for each respective compute cluster to execute the application.

8. The system of claim 7, wherein the scaling subsystem estimates the minimum estimated execution time for each respective compute cluster to execute the application based on the measured execution time and a calculated maximum scaling thread ratio, and
wherein the scaling subsystem calculates the maximum scaling thread ratio for each respective compute cluster based on the number of cores of each respective compute cluster divided by the first number of cores in the first compute cluster associated with the measured execution time.

9. The system of claim 8, wherein the scaling subsystem adjusts the maximum scaling thread ratio of each respective compute cluster by a ratio of a clock speed of the first compute cluster associated with the measured execution time and a clock speed of each respective compute cluster.

10. The system of claim 7, wherein the scaling subsystem estimates the maximum estimated execution time for each respective compute cluster to execute the application based on the measured execution time and a calculated minimum scaling ratio, wherein the scaling subsystem calculates the minimum scaling thread ratio as:
unity, for compute clusters having a number of cores equal to or exceeding the first number of cores of the first compute cluster associated with the measured execution time, and
a function of the number of cores of each respective compute cluster divided by the first number of cores in the first compute cluster associated with the measured execution time, for compute clusters having a number of cores less than the first number of cores.

11. A non-transitory computer-readable medium with instructions stored thereon that, when executed by a processor of a computing device, cause the computing device to:
determine a first measured execution time for a first number of cores of a first compute cluster to execute an application process;
determine a second measured execution time for a second number of cores of a second compute cluster to execute the application process;
calculate a thread scaling ratio of the application process based on:
(i) the first measured execution time,
(ii) the second measured execution time,
(iii) the first number of cores of the first compute cluster that executed the application process, and
(iv) the second number of cores of the second compute cluster that executed the application process; and
calculate an estimated execution time for a third compute cluster that has a third number of cores to execute the application process based on:
(i) the calculated thread scaling ratio of the application process,
(ii) the first measured execution time,
(iii) the first number of cores of the first compute cluster that executed the application process, and
(iv) the third number of cores of the third compute cluster.

12. The non-transitory computer-readable medium of claim 11, wherein the instructions further cause the computing device to:
determine a first number of reserved cores reserved by the first compute cluster for operations other than execution of the application process;
determine a second number of reserved cores reserved by the second compute cluster for operations other than execution of the application process; and
wherein the thread scaling ratio is further calculated based on:
the first number of reserved cores reserved by the first compute cluster for operations other than execution of the application process, and
the second number of reserved cores reserved by the second compute cluster for operations other than execution of the application process.

13. The non-transitory computer-readable medium of claim 11, wherein the instructions further cause the computing device to:
determine a first number of reserved cores reserved by the first compute cluster for operations other than execution of the application process;
determine a second number of reserved cores reserved by the second compute cluster for operations other than execution of the application process;
estimate a number of cores to be reserved by the third compute cluster for operations other than execution of the application process based on:
the first number of reserved cores reserved by the first compute cluster for operations other than execution of the application process, and
the second number of reserved cores reserved by the second compute cluster for operations other than execution of the application process; and
calculate the estimated execution time based further on the estimated number of cores to be reserved by the third compute cluster for operations other than execution of the application process.

14. The non-transitory computer-readable medium of claim 11, wherein the instructions cause the computing device to calculate the thread scaling ratio of the application process based further a ratio of a clock speed of the first compute cluster and a clock speed of the second compute cluster.

15. The non-transitory computer-readable medium of claim 11, wherein the instructions cause the computing device to calculate the estimated execution time based further on a ratio of a clock speed of the third compute cluster and a clock speed of the first compute cluster.
